(19) United States
(12) Patent Application Publication
(10) Pub. No.: US 2008/0247464 A1
(43) Pub. Date: Oct. 9, 2008

(54) METHOD AND APPARATUS FOR ENCODING AND DECODING BASED ON INTRA PREDICTION USING DIFFERENTIAL EQUATION

(75) Inventors: Vadim SEREGIN, Suwon-si (KR); Maxim KOROTEEV, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/854,095

(22) Filed: Sep. 12, 2007

(30) Foreign Application Priority Data
Apr. 6, 2007 (KR) 10-2007-0034419

(51) Int. Cl. H04B 1/66

(52) U.S. Cl. 375/240.12

(57) ABSTRACT

Provided are a method and apparatus for encoding and decoding an image based on intra prediction. The image encoding method comprises determining boundary values of a differential equation that is to be used to intra-predict a current block based on pixel values of pre-encoded pixels adjacent to the current block, predicting the current block using the differential equation and the boundary values and encoding the current block based on the prediction block of the current block.

### CROSS-REFERENCE TO RELATED PATENT APPLICATION

This application claims priority from Korean Patent Application No. 10-2007-0034419, filed on Apr. 6, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate encoding and decoding based on intra prediction, and more particularly, to increasing a compression rate of image data encoding by accurately predicting a current block that is to be encoded.

2. Description of the Related Art

In related art methods of compressing an image, such as MPEG-1, MPEG-2, MPEG-4 and H.264/MPEG-4 advanced video coding (AVC), a picture is divided into macro blocks in order to encode an image. Then, each macro block is encoded using inter prediction and intra prediction. Next, the macro blocks are encoded after selecting a suitable encoding mode by considering a data size of the encoded macro block and distortion of the original macro block.

In intra prediction, a macro block of a current picture is encoded using pixel values spatially adjacent to the current block that is to be encoded, instead of a reference picture. First, a prediction value of the current block that is to be encoded is calculated using the adjacent pixel values. Then, a difference between the prediction value and a pixel value of the original current block is encoded. Here, intra prediction modes can be largely divided into an intra prediction mode in luminance components and an intra prediction mode in chrominance components. The intra prediction mode in luminance components is divided into a 4×4 intra prediction mode, an 8×8 intra prediction mode, and a 16×16 intra prediction mode.

FIG. 1 illustrates a related art 16×16 intra prediction mode. Referring to FIG. 1, the 16×16 intra prediction mode includes a total of four modes, i.e., a vertical mode, a horizontal mode, a direct current (DC) mode, and a plane mode.

FIG. 2 illustrates a related art 4×4 intra prediction mode. Referring to FIG. 2, the 4×4 intra prediction mode includes a total of nine modes, i.e., a vertical mode, a horizontal mode, a DC mode, a diagonal down-left mode, a diagonal down-right mode, a vertical right mode, a vertical left mode, a horizontal-up mode, and a horizontal-down mode.

Prediction mode numbers indexed in each mode are determined based on the frequency with which each mode is used. The vertical mode, i.e., mode 0, is the most frequently used mode while performing intra prediction on a corresponding block, and the horizontal-up mode, i.e., mode 8, is the least used.

As an example, operations of prediction encoding a 4×4 current block using mode 0 of FIG. 2, i.e., the vertical mode, will be described. First, pixel values of pixels A through D, adjacent to an upper part of the 4×4 current block, are predicted as pixel values of the 4×4 current block. That is, the pixel value of pixel A is predicted as four pixel values included in the first column of the 4×4 current block, the pixel value of pixel B is predicted as four pixel values included in the second column of the 4×4 current block, the pixel value of pixel C is predicted as four pixel values included in the third column of the 4×4 current block, and the pixel value of pixel D is predicted as four pixel values included in the fourth column of the 4×4 current block. Next, a difference between the prediction values of the 4×4 current block predicted using pixels A through D and actual values of pixels included in the original 4×4 current block is obtained, and a bitstream of the 4×4 current block is generated by encoding the difference.

In encoding an image according to the H.264 standard, a current block is encoded using a total of 13 modes from the 4×4 intra prediction mode and the 16×16 intra prediction mode in order to generate a bitstream of the current block according to the optimum mode.

The related art intra prediction methods illustrated in FIGS. 1 and 2 predict the current block using pixels adjacent to the current block, i.e., pixels included in at least one of left, upper, and upper-left blocks.

However, if pixel values of pixels included in the current block do not have a correlation in an intra prediction direction, the related art intra prediction methods cause an increase in a residue of the current block, which reduces the compression rate of image data. Therefore, a method and apparatus for more accurately predicting pixel values of a current block are needed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for encoding and decoding based on intra prediction that can more accurately predict a current block using a differential equation indicating the characteristics of pixel values of the current block, and a computer readable recording medium having recorded thereon a program for executing the method.

According to an aspect of the present invention, there is provided an image encoding method comprising: determining boundary values of a differential equation that is to be used to intra-predict a current block based on pixel values of pre-encoded pixels adjacent to the current block; predicting the current block using the differential equation and the boundary values; and encoding the current block based on the prediction block of the current block.

The determining of the boundary values may comprise: predicting pixel values of non-encoded pixels adjacent to the current block based on pixel values of pre-encoded pixels adjacent to the current block; and determining the pixel values of the pre-encoded pixels adjacent to the current block and the predicted pixel values of non-encoded pixels adjacent to the current block as the boundary values of the partial differential equation.

According to another aspect of the present invention, there is provided an image encoding apparatus comprising: a boundary value determination unit determining boundary values of a differential equation that is to be used to intra-predict a current block based on pixel values of pre-encoded pixels adjacent to the current block; a prediction unit predicting the current block using the differential equation and the boundary values; and an encoding unit encoding the current block based on the prediction block of the current block.

According to another aspect of the present invention, there is provided an image decoding method comprising: receiving a bitstream including data of a current block, and extracting information indicating that the current block is intra-prediction encoded using a differential equation from the bitstream; predicting the current block using the differential equation based on the information; and reconstructing the current block based on the prediction block of the current block.

The predicting of the current block may comprise: determining boundary values of the partial differential equation that is to be used to predict the current block based on pixel values of pre-decoded pixels adjacent to the current block; and predicting the current block using the partial differential equation and the boundary values.

According to another aspect of the present invention, there is provided an image decoding apparatus comprising: a decoding unit receiving a bitstream including data of a current block, and extracting information indicating that the current block is intra-prediction encoded using a differential equation from the bitstream; a prediction unit predicting the current block using the differential equation based on the information; and a reconstruction unit reconstructing the current block based on the prediction block of the current block.

The differential equation may be a partial differential equation.

The prediction unit may comprise: a boundary value determination unit determining boundary values of the partial differential equation that is to be used to predict the current block based on pixel values of pre-decoded pixels adjacent to the current block; and a prediction performing unit predicting the current block using the partial differential equation and the boundary values.

The partial differential equation may be an elliptic partial differential equation or a hyperbolic partial differential equation.

According to another aspect of the present invention, there is provided a computer readable recording medium having recorded thereon a program for executing the method of encoding and decoding an image.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a related art 16×16 intra prediction mode;

FIG. 2 is a diagram illustrating a related art 4×4 intra prediction mode;

FIG. 3 is a block diagram of an image encoding apparatus including an intra-prediction device according to an exemplary embodiment of the present invention;

FIG. 4 is a diagram illustrating boundary values of a partial differential equation according to an exemplary embodiment of the present invention;

FIG. 5 is a diagram illustrating a method of predicting boundary values using linear interpolation according to an exemplary embodiment of the present invention;

FIG. 6A is a diagram illustrating an intra-prediction method according to an exemplary embodiment of the present invention;

FIG. 6B is a diagram illustrating a method of obtaining a solution of a partial differential equation according to an exemplary embodiment of the present invention;

FIG. 7 is a flowchart illustrating an image encoding method according to an exemplary embodiment of the present invention;

FIG. 8 is a block diagram of an image decoding apparatus including an intra-prediction device according to an exemplary embodiment of the present invention;

FIG. 9 is a block diagram of a prediction unit according to an exemplary embodiment of the present invention; and

FIG. 10 is a flowchart illustrating an image decoding method according to an exemplary embodiment of the present invention.

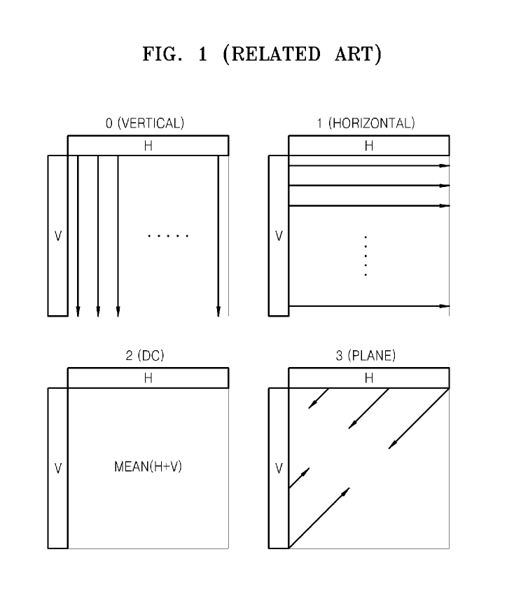

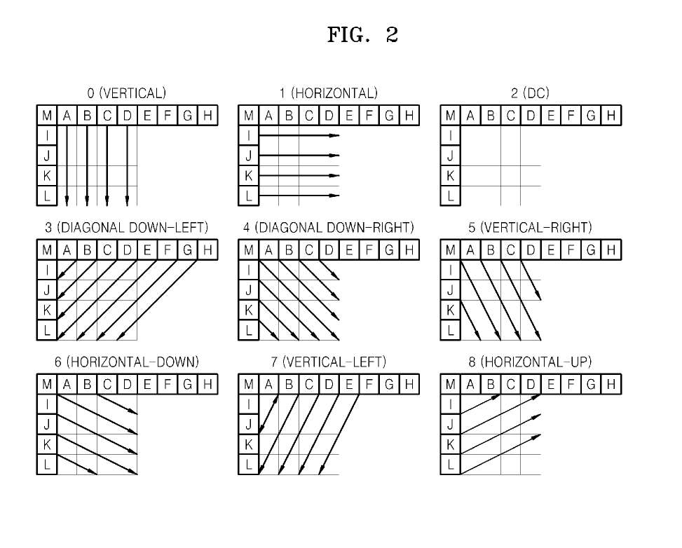

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

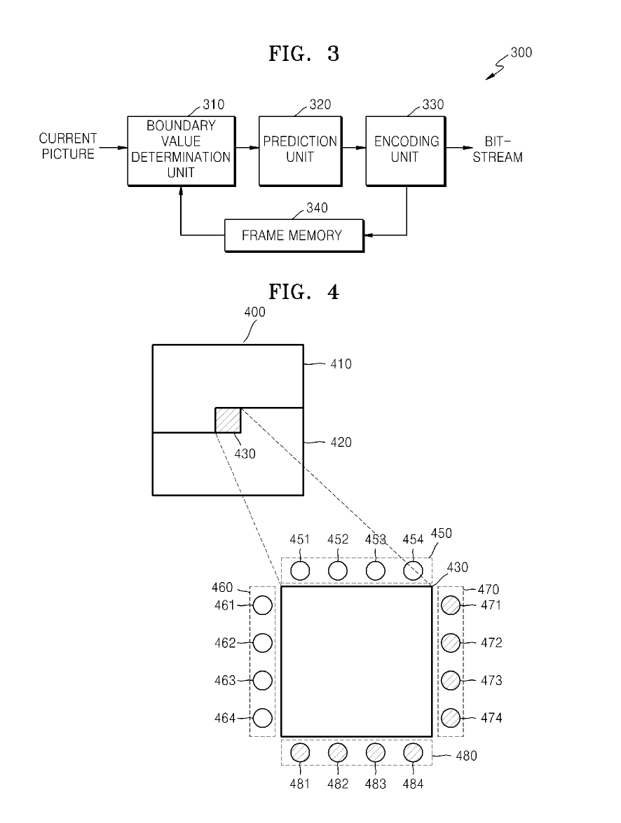

FIG. 3 is a block diagram of an image encoding apparatus 300 including an intra-prediction device according to an exemplary embodiment of the present invention. Referring to FIG. 3, the image encoding apparatus 300 includes a boundary value determination unit 310, a prediction unit 320, an encoding unit 330, and a frame memory 340. The boundary value determination unit 310 and the prediction unit 320 correspond to an intra prediction performing apparatus according to an exemplary embodiment of the present invention.

The image encoding apparatus 300 provides a new mode of an intra prediction method other than the related art intra prediction methods in order to intra-predict a current block. The image encoding apparatus 300 selects a differential equation to be applied to intra-predict a current block according to the characteristics of the current block, and obtains a solution of the differential equation, thereby intra-predicting the current block. Hereinafter, a partial differential equation will be applied to intra-predict the current block, for descriptive convenience.

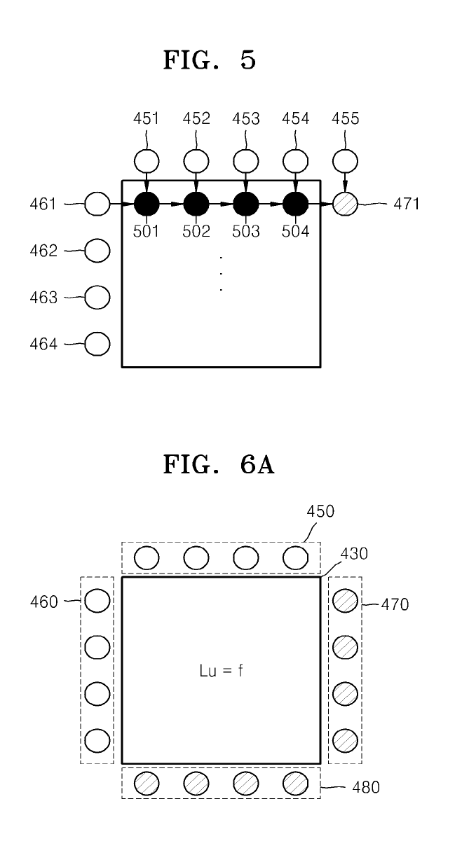

The boundary value determination unit 310 determines boundary values of the partial differential equation to be applied to intra-predict the current block based on pre-encoded pixel values of pixels adjacent to the current block. The pre-encoded pixel values are stored in the frame memory 340. This will now be described in detail with reference to FIGS. 4 and 5.

FIG. 4 illustrates boundary values of the partial differential equation according to an exemplary embodiment of the present invention. Referring to FIG. 4, a current picture 400 is divided into a pre-encoded area 410 and non-encoded area 420 which are adjacent to a current block 430. If the current block 430 is a 4×4 block, pixels 450 and 460 adjacent to upper and left parts of the current block 430 are included in the pre-encoded area 410 of the current picture 400 and have pre-encoded pixel values.

The boundary value determination unit 310 determines pixel values of pixels 450 through 480 adjacent to the current block 430 as boundary values of the partial differential equation to be applied to intra-predict the current block 430.

If the prediction unit 320 uses a hyperbolic partial differential equation to intra-predict the current block 430, the boundary value determination unit 310 determines the pixel values of the pixels 450 and 460 included in the pre-encoded area 410 from among the pixels 450 through 480 adjacent to the current block 430 as the boundary values of the partial differential equation.

If the prediction unit 320 uses an elliptic partial differential equation to intra-predict the current block 430, the boundary value determination unit 310 determines the pixel values of the pixels 470 and 480 included in the non-encoded area 420 from among the pixels 450 through 480 adjacent to the current block 430 as the boundary values of the partial differential equation.

However, if the pixel values of the pixels 470 and 480 included in the non-encoded area 420 from among the pixels 450 through 480 adjacent to the current block 430 are used to intra-predict the current block 430, pixels included in a non-decoded area are required to intra-predict the current block 430, making it impossible to decode an image.

Therefore, the boundary value determination unit 310 predicts the pixels 470 and 480 included in the non-encoded area 420 using the pixels 450 and 460 included in the pre-encoded area 410 from among the pixels 450 through 480 adjacent to the current block 430, and determines prediction values of the pixels 470 and 480 as the boundary values of the partial differential equation.

The pixels 450 and 460 included in the pre-encoded area 410 can be duplicated and used as the pixel values of the pixels 470 and 480 included in the non-encoded area 420. In more detail, the pixel values of the pixels 460 adjacent to a left part of the current block 430 are duplicated and used as the pixel values of the pixels 470 adjacent to a right part of the current block 430, or the pixel values of the pixels 450 adjacent to the right part of the current block 430 are duplicated and used as the pixel values of the pixels 480 adjacent to a lower part of the current block 430.

The related art intra-prediction methods can be used to predict the pixel values of the pixels 470 and 480 of the non-encoded area 420. For example, the mean of the pixel values of the pixels 450 and 460 included in the pre-encoded area 410 can be calculated and used as the pixel values of the pixels 470 and 480 included in the non-encoded area 420.

Linear interpolation may be used to predict the pixel values of the pixels 470 and 480 included in the non-encoded area 420. This will be described in detail with reference to FIG. 5.

FIG. 5 illustrates how to predict boundary values using linear interpolation according to an exemplary embodiment of the present invention. The linear interpolation is performed using two pixels adjacent to each pixel.

Referring to FIG. 5, the pixels 470 and 480 included in the non-encoded area 420 of the current block 430 are predicted from the pixels 450 and 460 included in the pre-encoded area 410 of the current block 430 using the linear interpolation.

Among pixels 501 through 504 included in the current block 430, the pixel 501 adjacent to the left-upper part of the current block 430 is predicted using pixel values of pixels 451 and 461 adjacent to the upper and left parts, respectively, of the current block 430. The mean of the pixel values of both pixels 451 and 461 can be used as a prediction value of the pixel 501, or the mean of both pixels 451 and 461 each having a different weight can be used to generate the prediction value of the pixel 501.

The pixel 502 is predicted using a pixel value of a pixel 452 adjacent to the upper part of the current block 430 and the prediction value of the pixel 501. Such prediction is performed with regard to a row of the pixels 501 through 504 in order to predict a pixel 471 adjacent to the right part of the current block 430 using a prediction value of the pixel 504 included in the current block and a pixel value of a pixel 455 adjacent to the upper part of the current block 430.

If all the pixel values of the pixels 470 and 480 included in the non-encoded area 420 are predicted by repeating the prediction of boundary values, the prediction values of the pixels 470 and 480 and the pixel values of the pixels 450 and 460 of the pre-encoded area 410 are determined as the boundary values of the partial differential equation.

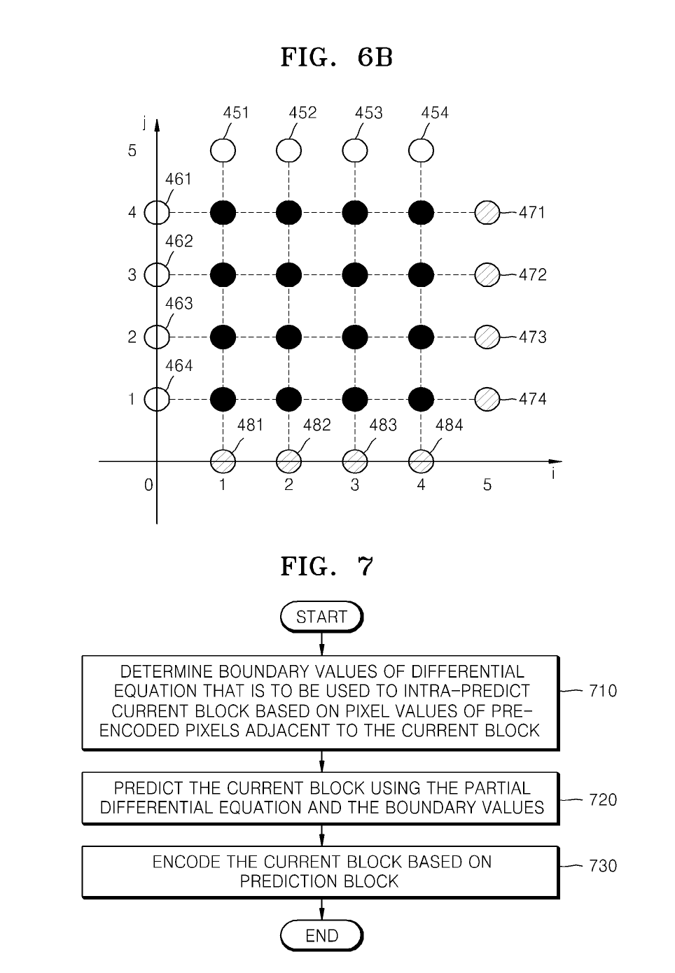

If the boundary value determination unit 310 determines the boundary values according to the hyperbolic partial differential equation or the elliptic partial differential equation, the prediction unit 320 intra-predicts the current block 430 using the partial differential equation and the boundary values. This will now be described in detail with reference to FIGS. 6A and 6B.

FIG. 6A illustrates an intra-prediction method according to an exemplary embodiment of the present invention. Referring to FIG. 6A, the prediction unit 320 selects the partial differential equation to be applied to intra-predict the current block 430 according to equation 1,

L·u(x,y)=f(x,y) (1)

wherein L denotes a partial differential operator of the partial differential equation, u(x,y) denotes a solution of the partial differential equation and is a quadratic function used to obtain a prediction value of the current block 430 in the present exemplary embodiment, and f(x,y) denotes a function of x and y in which if f(x,y) is 0. Equation 1 is a homogeneous equation. L and f(x,y) vary depending on the model of the partial differential equation used to intra-predict the current block 430. If L is the Laplace operator of the elliptic partial differential equation, i.e.,

$$L = \frac{{\partial }^{2}}{\partial {x}^{2}} + \frac{{\partial }^{2}}{\partial {y}^{2}} ,$$

equation 1 is given by

$$\frac{{\partial }^{2} u ( x , y )}{\partial {x}^{2}} + \frac{{\partial }^{2} u ( x , y )}{\partial {y}^{2}} = f ( x , y ) \qquad ( 2 )$$

FIG. 6B illustrates a method of obtaining a solution of a partial differential equation according to an exemplary embodiment of the present invention. In the present exemplary embodiment, the solution of equation 2 is obtained using numerical analysis.

In the numerical analysis of the partial differential equation, u(x,y) is identified with lattices at regular intervals and a value of u(x,y) is obtained from the lattices so that the solution of the partial differential equation is obtained. In this regard, approximation of differential operations is given by,

$$\frac{{\partial }^{2} u ( x , y )}{\partial {x}^{2}} = \frac{{u}_{i - 1 , j} - 2 {u}_{i , j} + {u}_{i + 1 , j}}{{h}^{2}} \\ \frac{{\partial }^{2} u ( x , y )}{\partial {y}^{2}} = \frac{{u}_{i , j + 1} - 2 {u}_{i , j} + {u}_{i , j - 1}}{{h}^{2}} \qquad ( 3 )$$

wherein h denotes an interval between the lattices illustrated in FIG. 6B, i=1 to N−1, and j=1 to M−1. If a 4×4 block is intra-predicted, M=N=5. If the interval between the lattices is 1, equation 2 is given by

u_{i-1,j}−2u_{i,j}+u_{i+1,j}+u_{i,j+1}−2u_{i,j}+u_{i,j-1}=f_{i,j} (4)

Equation 2 is changed to a linear algebra equation and thus a value of each lattice is obtained using an iterative method.

The solution of the partial differential equation is obtained using the iterative methods such as Gauss-Seidel, successive over relaxation (SOR), alternating direction implicit (ADI) and the like, which can be easily understood by one of ordinary skill in the art.

Boundary values shown in FIG. 6B, i.e., values of pixels 451 through 454, 461 through 464, 471 through 474, and 481 through 484 adjacent to the current block 430, are already determined by the boundary value determination unit 310. Thus, the boundary values and the partial differential equation are used to obtain the value of each lattice, i.e., a prediction value of each pixel.

Although the method of predicting the current block 430 uses the elliptic partial differential equation in the present exemplary embodiment, the intra-prediction method of the present invention is not limited thereto, and a method of predicting the current block 430 using the hyperbolic partial differential equation is within the scope of the intra-prediction method of the present invention.

When the current block 430 is predicted using the hyperbolic partial differential equation, as described above, the pixel values of the pixels 450 and 460 included in the pre-encoded area 410 among the pixels 450 through 480 adjacent to the current block 430 are determined as the boundary values of the partial differential equation and the solution of the partial differential equation. A process of obtaining the solution of the hyperbolic partial differential equation is defined as a process of solving a problem of boundary values of a wave equation called the “Gursa problem”.

A residual block including a residual value of each pixel is transformed into the frequency domain discrete cosine transform (DCT). The DCT coefficients are quantized and entropy-encoded so that a bitstream including data of the current block 430 is generated. In this regard, information indicating that the current block 430 is intra-prediction encoded using a differential equation, preferably, a partial differential equation, is encoded.

The encoded residual block is reconstructed after being inverse-quantized and inverse-discrete-cosine-transformed so that the reconstructed residual block is used to predict a next block. The reconstructed residual block is added to a prediction block generated in the prediction unit 320 and then stored in the frame memory 340.

FIG. 7 is a flowchart illustrating an image encoding method according to an exemplary embodiment of the present invention. Referring to FIG. 7, an image encoding apparatus determines boundary values of a differential equation that is to be used to intra-predict a current block based on pixel values of pre-encoded pixels adjacent to the current block (Operation 710).

If a hyperbolic partial differential equation is used to predict the current block, the pixel values of pre-encoded pixels adjacent to the current block are determined as the boundary values of the differential equation.

However, if an elliptic partial differential equation is used to predict the current block, the pixel values of pre-encoded pixels adjacent to the current block are used to predict pixel values of non-encoded pixels adjacent to the current block. If all the pixel values of non-encoded pixels adjacent to the current block are predicted, the pixel values of pre-encoded pixels and the predicted pixel values are determined as the boundary values of the partial differential equation.

The image encoding apparatus selects the partial differential equation that is to be used to predict the current block, obtains a solution of the selected partial differential equation based on the boundary values, and predicts the current block (Operation 720).

The image encoding apparatus encodes the current block based on the prediction block (Operation 730). The prediction block is subtracted from the current block and a residual block is generated. The residual block is discrete-cosine-transformed into the frequency domain. The DCT coefficients are quantized and entropy-encoded.

Information indicating that the current block is intra-prediction encoded using a differential equation is encoded.

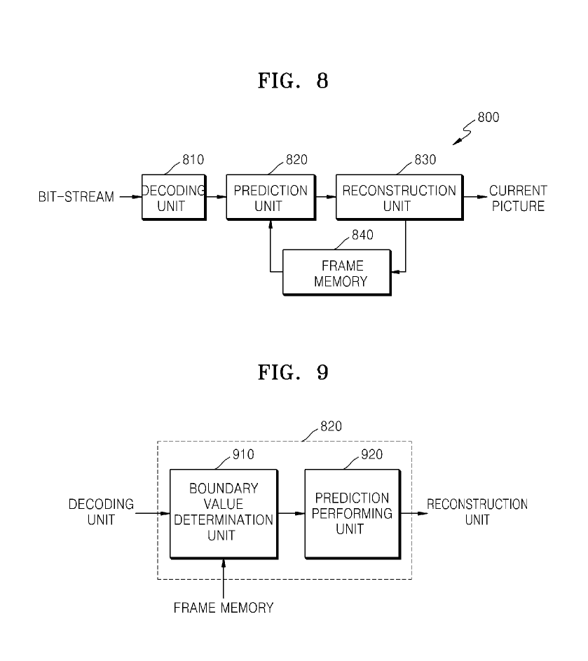

FIG. 8 is a block diagram of an image decoding apparatus 800 according to an exemplary embodiment of the present invention. Referring to FIG. 8, the image decoding apparatus 800 includes a decoding unit 810, a prediction unit 820, a reconstruction unit 830, and a frame memory 840. The prediction unit 820 corresponds to an intra-prediction performing apparatus according to the present invention.

The decoding unit 810 receives a bitstream including data of a current block, and extracts information indicating that the current block is intra-prediction encoded using a differential equation from the bitstream. Hereinafter, a partial differential equation will be applied to intra-predict the current block with regard to the image decoding apparatus 800.

The data on the current block includes data on a residual block of the current block and information indicating that the current block is intra-prediction encoded using a partial differential equation. The data on the residual block is extracted from the bitstream, entropy-decoded, inverse-quantized, and inverse-discrete-cosine-transformed.

The prediction unit 820 predicts the current block using the partial differential equation based on the information extracted in the decoding unit 810. This will now be described in detail with reference to FIG. 9.

FIG. 9 is a block diagram of the prediction unit 820 according to an exemplary embodiment of the present invention. Referring to FIG. 9, the prediction unit 820 of the image decoding apparatus 800 includes a boundary value determination unit 910 and a prediction performing unit 920.

The boundary value determination unit 910 determines boundary values of a partial differential equation that is to be used to intra-predict a current block. If a hyperbolic partial differential equation is used to predict the current block, the pixel values of pre-encoded pixels adjacent to the current block are determined as the boundary values of the partial differential equation.

However, if an elliptic partial differential equation is used to predict the current block, the pixel values of pre-encoded pixels adjacent to the current block are used to predict pixel values of non-encoded pixels adjacent to the current block. The method of predicting the boundary values with reference to FIGS. 4 and 5 is used in the decoding process in a symmetrical manner.

If all the pixel values of non-encoded pixels adjacent to the current block are predicted, the pixel values of pre-encoded pixels and the predicted pixel values are determined as the boundary values of the partial differential equation.

The prediction performing unit 920 intra-predicts the current block based on the boundary values determined in the boundary value determination unit 910. A solution of the partial differential equation that is to be used to intra-predict the current block is obtained based on the boundary values to predict the current block.

The reconstruction unit 830 reconstructs the current block based on the intra-prediction block obtained in the prediction unit 820. The prediction unit 820 adds the prediction block of the current block obtained using the partial differential equation and the decoded residual block obtained in the decoding unit 810 in order to reconstruct the current block.

The reconstructed current block is stored in the frame memory 840 and is used to predict a next block.

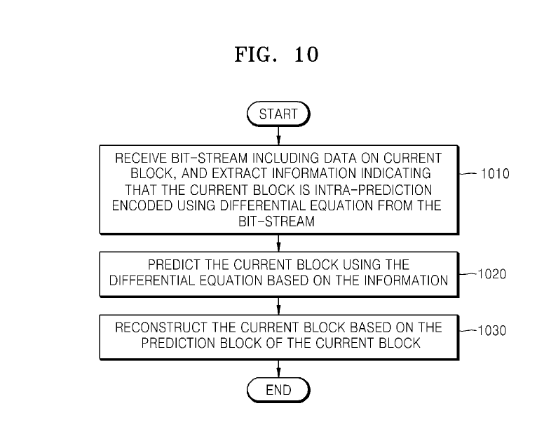

FIG. 10 is a flowchart illustrating an image decoding method according to an exemplary embodiment of the present invention. Referring to FIG. 10, an image decoding apparatus receives a bitstream including data on a current block, and extracts information indicating that the current block is intra-prediction encoded using a differential equation from the bitstream (Operation 1010). Data on a residual block of the current block is extracted from the bitstream, entropy-decoded, inverse-quantized, inverse-discrete-cosine-transformed, and then decoded. The differential equation can be a partial differential equation.

The image decoding apparatus predicts the current block using the differential equation based on the information (Operation 1020). In the partial differential equation, boundary values of the partial differential equation are first determined and a solution of the partial differential equation is obtained based on the boundary values so that the current block is intra-predicted.

As described above, a hyperbolic partial differential equation and elliptic partial differential equation have different boundary values.

The image decoding apparatus reconstructs the current block based on the prediction block of the current block (Operation 1030). The prediction block is added to the decoded residual block in order to reconstruct the current block.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks and optical data storage devices The computer readable recording medium can also be distributed over network coupled computer systems so that the computer readable code is stored and executed in a distributed fashion.

According to the present invention, a differential equation suitable for the characteristics of a current block is used to intra-predict the current block, thereby more accurately predicting the current block and thus increasing the compression rate of image data.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image encoding method comprising:
determining boundary values of a differential equation that is to be used to intra-predict a current block based on pixel values of pre-encoded pixels adjacent to the current block;
predicting the current block using the differential equation and the determined boundary values; and
encoding the current block based on the predicted current block.

2. The method of claim 1, wherein the differential equation is a partial differential equation.

3. The method of claim 2, wherein the partial differential equation is an elliptic partial differential equation.

4. The method of claim 3, wherein the determining the boundary values comprises:
predicting pixel values of non-encoded pixels adjacent to the current block based on the pixel values of the pre-encoded pixels adjacent to the current block; and
determining the pixel values of the pre-encoded pixels adjacent to the current block and the predicted pixel values of the non-encoded pixels adjacent to the current block as the boundary values of the partial differential equation.

5. The method of claim 3, wherein the elliptic partial differential equation uses a Laplace operator.

6. The method of claim 2, wherein the partial differential equation is a hyperbolic partial differential equation.

7. An image encoding apparatus comprising:
a boundary value determination unit which determines boundary values of a differential equation that is to be used to intra-predict a current block based on pixel values of pre-encoded pixels adjacent to the current block;
a prediction unit which predicts the current block using the differential equation and the boundary values determined by the boundary value determination unit; and
an encoding unit which encodes the current block based on the predicted current block.

8. The apparatus of claim 7, wherein the differential equation is a partial differential equation.

9. The apparatus of claim 8, wherein the partial differential equation is an elliptic partial differential equation.

10. The apparatus of claim 9, wherein the boundary value determination unit predicts pixel values of non-encoded pixels adjacent to the current block based on pixel values of the pre-encoded pixels adjacent to the current block, and determines the pixel values of the pre-encoded pixels adjacent to the current block and the predicted pixel values of the non-encoded pixels adjacent to the current block as the boundary values of the partial differential equation.

11. The apparatus of claim 8, wherein the elliptic partial differential equation uses a Laplace operator.

12. The apparatus of claim 7, wherein the partial differential equation is a hyperbolic partial differential equation.

13. An image decoding method comprising:
receiving a bitstream including data of a current block, and extracting information indicating that the current block is intra-prediction encoded using a differential equation from the bitstream;
predicting the current block using the differential equation based on the extracted information; and
reconstructing the current block based on the predicted current block.

14. The method of claim 13, wherein the differential equation is a partial differential equation.

15. The method of claim 14, wherein the predicting of the current block comprises:
determining boundary values of the partial differential equation that is to be used to predict the current block based on pixel values of pre-decoded pixels adjacent to the current block; and
predicting the current block using the partial differential equation and the boundary values.

16. The method of claim 15, wherein the partial differential equation is an elliptic partial differential equation.

17. The method of claim 15, wherein the determining of the boundary values comprises:
predicting pixel values of non-encoded pixels adjacent to the current block based on pixel values of the pre-decoded pixels adjacent to the current block; and
determining the pixel values of the pre-decoded pixels adjacent to the current block and the predicted pixel values of the non-encoded pixels adjacent to the current block as the boundary values of the partial differential equation.

18. The method of claim 15, wherein the partial differential equation is a hyperbolic partial differential equation.

19. An image decoding apparatus comprising:
a decoding unit which receives a bitstream including data of a current block, and extracts information indicating that the current block is intra-prediction encoded using a differential equation from the bitstream;
a prediction unit which predicts the current block using the differential equation based on the information extracted by the decoding unit; and
a reconstruction unit which reconstructs the current block based on the predicted current block.

20. The apparatus of claim 19, wherein the differential equation is a partial differential equation.

21. The apparatus of claim 20, wherein the prediction unit comprises:
a boundary value determination unit which determines boundary values of the partial differential equation that is to be used to predict the current block based on pixel values of pre-decoded pixels adjacent to the current block; and
a prediction performing unit which predicts the current block using the partial differential equation and the boundary values determined by the boundary value determination unit.

22. The apparatus of claim 21, wherein the partial differential equation is an elliptic partial differential equation.

23. The apparatus of claim 22, wherein the boundary value determination unit predicts pixel values of non-encoded pixels adjacent to the current block based on pixel values of the pre-decoded pixels adjacent to the current block, and determines the pixel values of the pre-decoded pixels adjacent to the current block and the predicted pixel values of the non-encoded pixels adjacent to the current block as the boundary values of the partial differential equation.

24. The apparatus of claim 20, wherein the partial differential equation is a hyperbolic partial differential equation.

25. A computer readable recording medium having recorded thereon a program for executing an image encoding method comprising:
determining boundary values of a differential equation that is to be used to intra-predict a current block based on pixel values of a plurality of pre-encoded pixels adjacent to the current block;
predicting the current block using the differential equation and the determined boundary values; and
encoding the current block based on the predicted current block.

26. A computer readable recording medium having recorded thereon a program for executing An image decoding method comprising:
receiving a bitstream including data of a current block, and extracting information indicating that the current block is intra-prediction encoded using a differential equation from the bitstream;
predicting the current block using the differential equation based on the extracted information; and
reconstructing the current block based on the predicted current block.
